(19) United States
(12) Patent Application Publication
(10) Pub. No.: US 2012/0253935 A1
(43) Pub. Date: Oct. 4, 2012

(54) METHOD AND APPARATUS FOR PRESENTING ALTERNATIVE SOCIO-SPATIAL STATES OF A USER

(75) Inventor: Jan Otto Blom, Lutry (FI)

(73) Assignee: Nokia Corporation, Espoo (FI)

(21) Appl. No.: 13/099,978

(22) Filed: May 3, 2011

Related U.S. Application Data
(60) Provisional application No. 61/469,957, filed on Mar. 31, 2011.

(51) Int. Cl. G06F 15/16; G06Q 30/00

(52) U.S. Cl. 705/14.58; 709/204

(57) ABSTRACT

An approach is provided for presenting alternative socio-spatial states of a user. The approach involves determining location information associated with a user and other location information associated with one or more other users. The approach also involves determining social interest information associated with the user and other social interest information associated with the one or more other users. The approach further involves processing the location information, the other location information, the social interest information, the other social interest information or combination thereof to cause, at least in part, identification of one or more proposed encounters with respect to the user and the one or more other users. The approach additionally involves generating a presentation of the one or more proposed encounters to the user.

### RELATED APPLICATIONS

This application claims the benefit of the earlier filing date under 35 U.S.C. §119(e) of U.S. Provisional Application Ser. No. 61/469,957 filed on Mar. 31, 2011, entitled “Method and Apparatus for Presenting Alternative Socio-Spatial States of a User,” the entirety of which is incorporated herein by reference.

### BACKGROUND

Service providers and device manufacturers (e.g., wireless, cellular, etc.) are continually challenged to deliver value and convenience to consumers by, for example, providing compelling network services. One area of development is social networking and relationship building including assisting consumers with managing social agendas. Accordingly, service providers and device manufacturers face significant technical challenges to enabling consumers to more efficiently discover such social relationships.

### SOME EXAMPLE EMBODIMENTS

Therefore, there is a need for an approach for proposing social encounters among users of a social network.

According to one embodiment, a method comprises determining location information associated with a user and other location information associated with one or more other users. The method also comprises determining social interest information associated with the user and other social interest information associated with the one or more other users. The method further comprises processing and/or facilitating a processing of the location information, the other location information, the social interest information, the other social interest information or combination thereof to cause, at least in part, identification of one or more proposed encounters with respect to the user and the one or more other users. The method also comprises causing, at least in part, a generation of a presentation of the one or more proposed encounters to the user.

According to another embodiment, an apparatus comprises at least one processor, and at least one memory including computer program code for one or more computer programs, the at least one memory and the computer program code configured to, with the at least one processor, cause, at least in part, the apparatus to determine location information associated with a user and other location information associated with one or more other users. The apparatus is also caused to determine social interest information associated with the user and other social interest information associated with the one or more other users. The apparatus is further caused to process and/or facilitate a processing of the location information, the other location information, the social interest information, the other social interest information or combination thereof to cause, at least in part, identification of one or more proposed encounters with respect to the user and the one or more other users. The apparatus is also caused to generate a presentation of the one or more proposed encounters to the user.

According to another embodiment, a computer-readable storage medium carries one or more sequences of one or more instructions which, when executed by one or more processors, cause, at least in part, an apparatus to determine location information associated with a user and other location information associated with one or more other users. The apparatus is also caused to determine social interest information associated with the user and other social interest information associated with the one or more other users. The apparatus is further caused to process and/or facilitate a processing of the location information, the other location information, the social interest information, the other social interest information or combination thereof to cause, at least in part, identification of one or more proposed encounters with respect to the user and the one or more other users. The apparatus is also caused to generate a presentation of the one or more proposed encounters to the user.

According to another embodiment, an apparatus comprises means for determining location information associated with a user and other location information associated with one or more other users. The apparatus also comprises means for determining social interest information associated with the user and other social interest information associated with the one or more other users. The apparatus further comprises means for processing and/facilitating a processing of the location information, the other location information, the social interest information, the other social interest information or combination thereof to cause, at least in part, identification of one or more proposed encounters with respect to the user and the one or more other users. The apparatus also comprises means for causing, at least in part, a generation of a presentation of the one or more proposed encounters to the user.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of proposing a social encounter according to one embodiment;

FIG. 2 is a diagram of the components of an encounter processing platform that is capable of proposing a social encounter, according to one embodiment;

FIG. 3 is a flowchart of a process for proposing a social encounter, according to one embodiment;

FIG. 4 is a flowchart of a process for generating a user interface, according to one embodiment;

FIG. 5 is a diagram of a user interface for setting preferences for proposing a social encounter, according to one embodiment;

FIG. 6 is a diagram of a user interface that is a map for displaying proposed social encounters, according to one embodiment;

FIG. 7 is a diagram of a user interface that is a list for displaying proposed social encounters, according to one embodiment;

FIG. 8 is a diagram of a user interface that is a map for displaying a proposed social encounter, alternative social encounters, and further encounters based on each of the proposed social encounter and the alternative social encounters, according to one embodiment;

FIG. 9 is a diagram of a user interface that is a list for displaying a proposed social encounter, alternative social encounters, and further encounters based on each of the proposed social encounter and the alternative social encounters, according to one embodiment;

FIG. 10 is a diagram of a user interface depicting an invitation to attend a social encounter and an advertisement, according to one embodiment;

FIG. 11 is an illustration of a list of probability thresholds and the costs to advertise based on the probability threshold, according to one embodiment.

FIG. 12 is a diagram of a user interface that is a list for displaying proposed social encounters including advertising information, according to one embodiment;

FIG. 13 is a diagram of hardware that can be used to implement an embodiment of the invention;

FIG. 14 is a diagram of a chip set that can be used to implement an embodiment of the invention; and

FIG. 15 is a diagram of a mobile terminal (e.g., handset) that can be used to implement an embodiment of the invention.

### DESCRIPTION OF SOME EMBODIMENTS

Examples of a method, apparatus, and computer program for proposing a social encounter are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term social encounter refers to any type of meeting between a user and other users, or a social experience that may be of interest to the user such as, but not limited to, dinner events, restaurant events, sporting events, happy hours, group meetings, family events, work related events, parties, night club events, exercise experiences, shopping, just getting together, etc.

Mobile recommender systems are currently on the rise for suggesting social networking connections or things to do. Various service providers are increasingly embedding features to their navigation services that can provide place based recommendations to a user, based on recommended restaurants nearby, for example. Also social networking services are entering the mobile recommendation space. For instance, some social networking services may provide a way to allow local businesses such as coffee shops or main street shops to attract customers to their premises through targeting mobile users of the social networking service.

First generation mobile recommender systems involve only location based recommendations, in which content that is relevant to the present location of the user is provided to the user. However, as the intelligence behind recommender systems increases, and as mobile phones start to become embedded with sensors, more complex attributes pertaining to the user's preferences will play a role in the algorithms yielding the recommended content. Social networking, as well as geo-routines of the user, may well be aspects that start to drive recommendation systems as the technology advances.

Consumers today typically use a mobile device that is continuously collecting data about the geographic and social routines of the user. Such data is analysed (either locally or on a server) and certain geographic and social properties are derived pertaining to the user. Such geo-social information can be used to generate a realistic set of future states (e.g. 5 hours from the present moment) all of which have a relatively high likelihood of actualizing. Simultaneously, a possibility is provided for third parties to embed commercial information as part of the possible future scenarios recommended to the users. Overall, such a mechanism can yield personally relevant recommendations, monetizable by a service provider through collaborating with third parties offering physical services in the locality of the user, such as retail, dining, entertainment, etc.

Coordinating a social calendar involves planning future events with one's friends, while taking into consideration a given size and geographic spread of one's social network, diversity of routines pertaining to individuals in one's social network, as well as various special offers associated with bars, restaurants, shops, etc.

For example, consider that a person wants to decide what to do on a Friday evening. The following types of questions may have to be answered in order to find a successful outcome to this problem:

1. Who is available to get together tonight?

2. Would the people that are available like to get a beer tonight?

3. What places do I prefer and what places might my friends prefer?

4. How does my current location affect where I can be in a few hours' time?

5. What commercial offerings might be associated with places nearby?

6. Does some place nearby have a special price on my favorite beer?

The claimed approach offers a solution to such a “constraint satisfaction” problem, by providing a set of realistic and relevant geo-social event alternatives to choose from for the user. The approach may also involve a mechanism for actualizing any given option that is eventually chosen by the user.

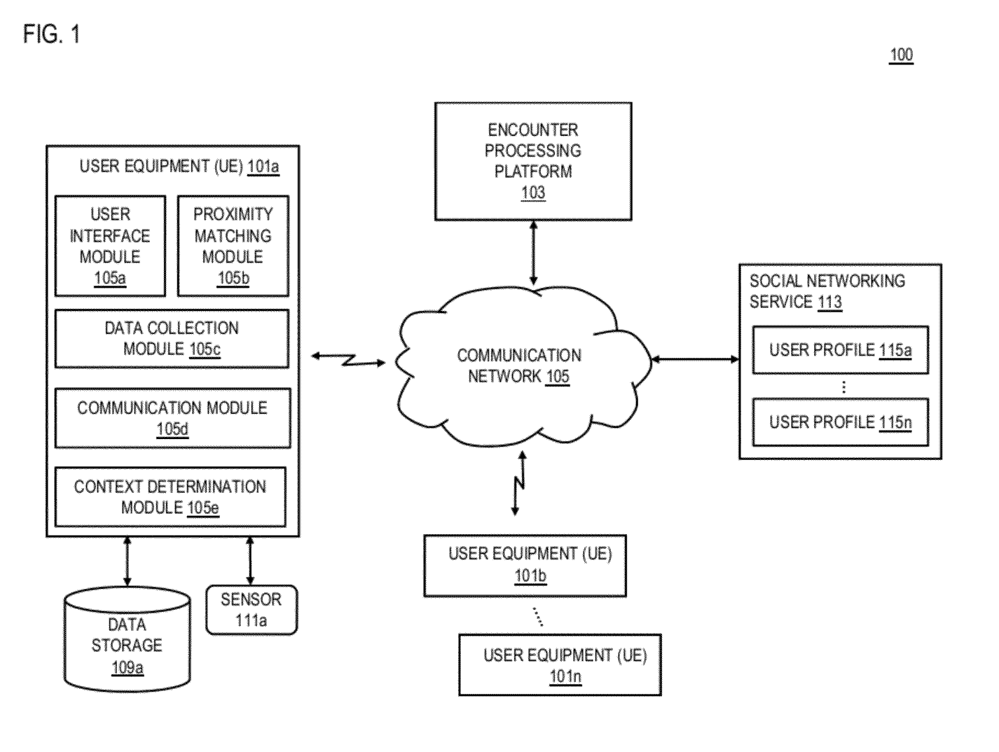

FIG. 1 is a diagram of a system capable of proposing a social encounter, according to one embodiment. People have a difficult time deciding what to do with their friends on any given occasion, would like to know their options, and how their decisions when planning events may affect the course of their day and their likelihood of attending future events. People would also like to have the ability to optimize the value of their dollar when attending a social gathering, and would like to know about any potential ways to save money, such as available coupons, that may be used when getting together with friends. Service providers and social networking providers, for example, would like to have the ability to monetize such social planning through advertising revenue.

To address these problems, a system 100 of FIG. 1 introduces the capability to suggest a social encounter based on location information of one or more users, social interests of the one or more users, commercial availability such as locations, activities of interest and/or available reservations, available discounts or specials at various establishments or events, a particular distance from the location of the one or more users, a time during which the one or more users are interested in proposed social encounters, additional location information such as a location of interest that the user is not currently at, or any combination thereof.

As shown in FIG. 1, the system 100 comprises user equipment (UE) 101 having connectivity to an encounter processing platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, UE 101 has a user interface module 105a through which a user may interact with the UE 101. A user may want to receive and view potential proposed social encounters that he may have with other users. The user may opt to receive potential proposed social encounters on the UE 101 on a periodic basis or on demand. The UE 101a may also be a means through which the user may view any proposed social encounters that are provided by the encounter processing platform 103. The UE 101 collects location information about the user by way of a sensor 111a, gps, geo-location, etc. and may store that information in a data storage 109a or it may immediately forward the location information to the encounter processing platform 103. The location information may be used by the encounter processing platform 103 to suggest a meeting between user and one or more other users within a particular proximity of the user. The UE 101 may also detect and store patterns of location information of the UE 101 (i.e. the user) to develop a trend or history of location patterns so that a future location could be predicted. Such a detection and determination may be done by a context determination module 105e that is part of the UE 101. For example, a user on a given Saturday wakes up in the morning, gets in his car, drives to a donut shop, then to the super market, then home, then goes golfing, and then to a bar. The UE 101 may store all of this information, and in the future suggest that the user go to a restaurant near the bar that he usually attends every Saturday.

The context determination module 105e may also determine the type of location at which the user is positioned, or it may determine a pace that the user moves throughout the day, or any type of context that may be used in comparing a user to other users for proposing a social encounter. The context determination module 105e receives the context information about the user from a data collection module 105c that may be interfaced, for example, with the sensor 111a, or may receive an input from the user by way of user interface 105a. A proximity matching module 105b may be incorporated into the UE 101, and if the sensor 111a detects that another user is nearby, the proximity matching module may indicate that a friend or another person nearby is using a same service, and the encounter processing platform 103 may use that information to propose a social encounter.

In one embodiment, the UE 101 and encounter processing platform 103 communicate with a social networking service 113. The social networking service 113 has a plurality of user profiles 115a-115n that indicate various social interests and connections that a user may have in common or related to other users of the social networking service 113. The social networking service 113 may also interact with the UE 101 to detect and store context information related to the user.

In one embodiment, the encounter processing platform 103 takes all of the information available including current location information, future location information, and/or location information of interest (e.g. a place where the user may want to be 5 hours from now) about the user and any other users, from their respective UE 101a-101n and/or social networking user profiles 115a-115n, and generates a range of proposed social encounters between the user and the one or more other users and may or may not also provide commercial availability information such as reservation information, advertisements, or discount offers.

By way of example, the UE 101, encounter processing platform 103, social networking service 113 and UE 101b-n communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

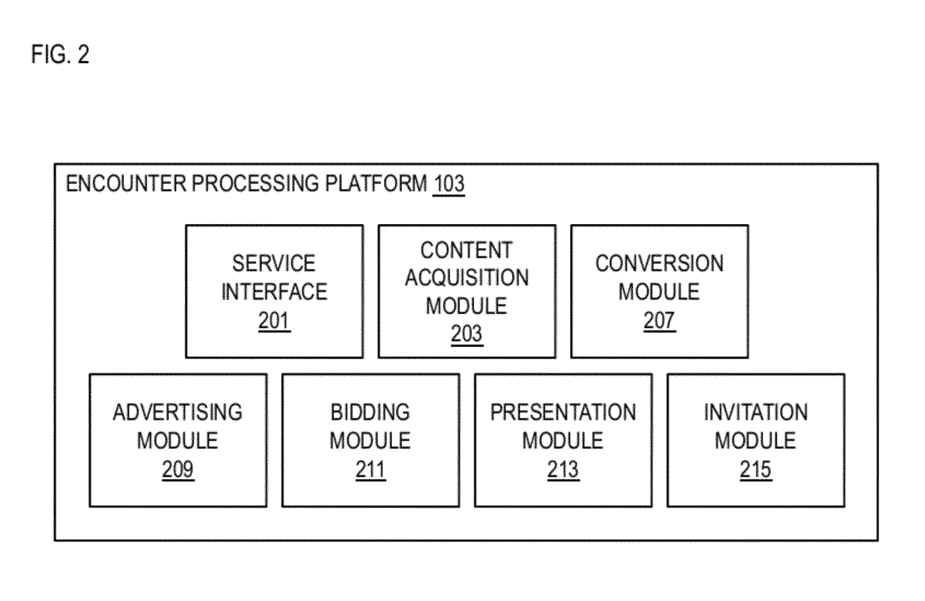

FIG. 2 is a diagram of the components of encounter processing platform 103 according to one embodiment. By way of example, the encounter processing platform 103 includes one or more components for providing a proposed social encounter. It is contemplated that the functions of these components may be combined in one or more components or performed by other components of equivalent functionality. In this embodiment, the encounter processing platform 103 includes a service interface 201, a content acquisition module 203, a suggestion module 207, an advertising module 209, a bidding module 211, a presentation module 213 and an invitation module 215.

In one embodiment, the service interface 201 establishes a communications link with the social networking service 113 so that the encounter processing platform 103 can receive any social interest information about the user or one or more other users. Social interest information may be, for example, likes and dislikes such as music, food, wine, liquor, movies, beer, media topics, financial interests, colleges, sporting events or teams, political views, religious views, relationship status, location, planned vacations, etc. By no means is this list totally inclusive. Rather is it merely an example of possible social interest items that the encounter processing platform 103 may take into consideration.

In one embodiment, the content acquisition module 203 establishes a communications link with the communication module 105d of UE 101 to receive information from the context determination module 105e. The content acquisition module 203 receives any context information that may be stored at the UE 101 or relayed to the encounter processing platform 103 that is about the user. Such information, as discussed above, may be used by the encounter processing platform to optimize a suggested encounter based on the location of the user, for example, which is combined with any social interest information that is received about the user and any other users. All of this information may be processed by a suggestion module 207.

In one embodiment, the suggestion module 207 receives all of the information from the service interface 201 and the content acquisition module 203 to determine proposed social encounters for the user to attend. The suggestion module 207 may, for example, based on the location of the user and the timing of which a suggestion process is run, propose one or more proposed social encounters for the user to attend. The suggestion module 207 may also, for example, propose a series of social encounters to the user based upon a first social encounter. In other words, if the suggestion module 207 proposes three proposed social encounters at three different locations all starting at 6 pm. The suggestion module 207 may then also suggest a second tier of three more social encounters each depending on which of the first three proposed social encounters that start at various locations at 8 pm. The suggestion module 207 may then still also suggest three more social encounters, for example, each depending on which of the second tier of proposed social encounters each of which starts at 11 pm. This level of detail of multiple proposed encounters enables a user to see how his evening, for example, may progress if one path is taken. In other words, this option may present what might be called a series of parallel universes in which a user may decide to partake. The above series of proposed social encounters is by no way exclusive to just three and also by no means exclusive to the particular timing of the proposed social encounters. A user could, for example, be presented with many proposed encounters and any subsequent encounter may be limited, for example, by a time of the encounter, a location of the encounter, or even a time of travel between any potential encounters.

In one embodiment, the suggestion module 207 may also take any available commercial venues into consideration when proposing a social encounter. For example, the suggestion module may detect that a restaurant is nearby that is in line with the user's interests and suggest that the user go there after work. The suggestion module 207, may also, in connection with the social networking service 113, determine that a restaurant, among other restaurants, may be booked and not have any available seating, so it will remove that restaurant from consideration during the times at which the proposed social encounter may be suggested.

In one embodiment, the suggestion module 207 may determine the probability that a user may attend a proposed social encounter, or the probability that a user may pass through a particular area based on his social interested and/or location pattern that is received from the UE 101, for example. The probabilities may be used to suggest a proposed social encounter, or to estimate the likelihood that the user will attend the event. That likelihood may be used to persuade potential advertisers that they should use their resources to send the user an advertisement such as a coupon to use during the proposed social encounter to increase the likelihood that the user will attend the proposed social encounter.

In one embodiment, the advertising module 209 receives information about a proposed encounter that may include the probability discussed above. The advertising module 209 may generate an advertisement that corresponds to a meeting place such as a bar or a restaurant that is proposed by the encounter processing platform 103, or it may generate an advertisement that corresponds to a general area of the proposed encounter. The probability discussed above may be a basis for charging a potential advertiser a set rate for sending an advertisement to the user and/or the one or more other users. The advertising module 209, however, may also communicate with a bidding module 211 that presents the probabilities of the likelihood of attendance at the proposed encounter to a plurality of third party advertisers, restaurateurs, merchants etc. that may bid to pay a particular amount to ensure that their advertisement is placed at the top of a list of advertisements sent to the user and/or the one or more other users. This bidding module 211 may also be capable of ensuring that a winning bid may enable the advertising module 209 to present the advertisement such that the advertisement is the only advertisement sent to the user and/or the one or more other users.

In one embodiment, the presentation module 213 generates a presentation of at least one proposed social encounter and any alternative social encounters and any events that might transpire from selecting one or more social encounters throughout a user's future. The presentation module 213 may communication with the invitation module 215 to generate an invitation to send to the user and/or the one or more other users to attend a proposed social encounter. While the user may be presented with a list of options, the user may still opt to receive an invitation so that the user may be able to view the invitation that is sent to his friends (i.e. the one or more other users). The invitation module 215 may communicate with the advertising module 209 to include an advertisement that is generated by the advertising module with the invitation that is generated by the invitation module 215.

In one embodiment, the encounter processing platform 103 may periodically generate and send proposed encounters to the user and/or the one or more other users, or it may perform this function on demand. The user may also have the ability by way of the user interface 105a to select from a list of one or more other users that may be available to attend the proposed social encounter to send the invitations to. For instance, a plurality of other users may be suggested by the encounter processing platform 103 that are detected as being connected to the user by way of the social networking service 113. But, not all of the other users of the social networking service 113 are actually friends with the user, or the user may not actually want to spend time with that person. So the user may have the option to screen which contacts are invited to the proposed social encounter, or which of the other users should be used in the proposed social encounter suggestion process. For example, the user may have the option to select, by way of the user interface 105a, a plurality of favorite friends that have a higher priority or that the search for available people to setup the proposed social encounter with may be limited to. The encounter processing platform 103 may also process proposed encounters blindly to setup a blind date, for example between the user and one or more other users based on their location and social interest information, for example. Other information such as patterns of behavior or overlap of time spent in a particular area may also be taken into consideration when proposing a social encounter.

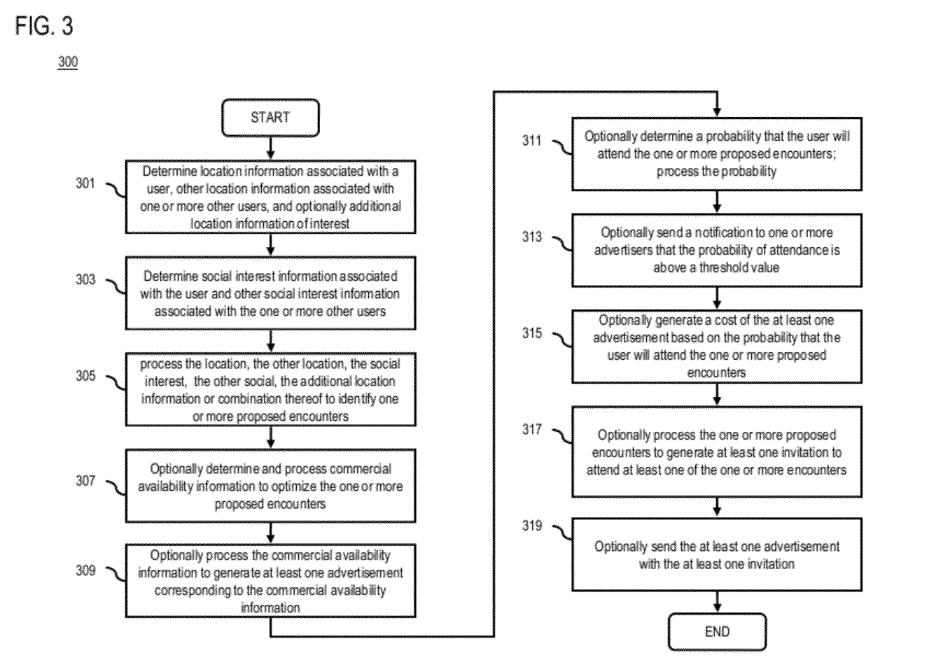

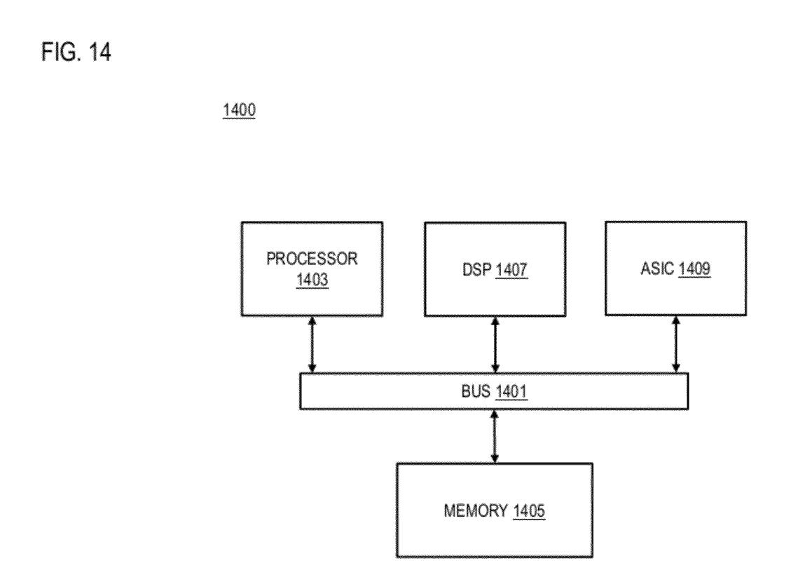

FIG. 3 is a flowchart of a process for proposing a social encounter according to one embodiment. In one embodiment, the encounter processing platform performs the process 300 and is implemented in, for instance, a chip set including a processor and a memory as shown in FIG. 14. In step 301, the encounter processing platform 103 determines the location of a user by way of the UE 101 and other location information relating to one or more other users by way of their respective UE 101b-n, or by way of their social networking profiles 115a-n. A user may also input additional location information such as areas of interest, or future locations at which the user plans to be positioned. The additional location information may also relate to probable locations that the use may be based on his historical patterns of movement or interests that may be stored in data storage 109a or in the user's own social networking profile 115a, for example. Next, the process continues to step 303 in which the encounter processing platform 103 determines social interest information that is associated with the user and social interest information associated with the one or more other users. The social interest information may be received from the social networking service 113 and/or the UE 101a-n. For example, the encounter processing platform 103 may process a user's interests relating to beer, golf, partying, dinner, types of food, types of music, etc. and compare that information with interests of other users to determine if there is any overlap to aid in the proposed encounter process.

The process continues to step 305 in which the encounter processing platform processes the location information about the user and the one or more other users and compounds that information with the social interest information to determine probable places and times that the user may want to meet up with other users. The process optionally continues to step 307 in which the encounter processing platform 103 may determine and process commercial availability information to optimize the one or more proposed encounters. Such commercial availability information may include, but not be limited to, venues that are close by, schedule events, reservation availability, etc. This commercial availability information may be combined with the location information and social interest information to develop a plurality of options for the user to attend and may optimize a proposed social encounter based on available pricing information, timing of availability and travel time between the locations of all of the users that are considered and the location of the proposed venues for the social encounter.

The process also optionally continues to step 309 in which the encounter processing platform 103 processes the commercial availability information and generates at least one advertisement. The at least one advertisement may be for a location that the encounter processing platform proposes or may be in the vicinity of the user or the one or more other users, a future location, a location of interest, and/or the location of the proposed encounter.

The process continues to step 311 in which the encounter processing platform 103 determines the probability that the user will attend a proposed encounter and sends this information to a potential advertiser. The encounter processing platform 103 also determines an appropriate pricing schedule based on the likelihood that the user will attend a proposed encounter, or the likelihood that the user will follow a particular path of travel in the user's future. For instance, if the user is likely to travel to the super market later in the day en route to a bar, then the encounter processing platform 103 may send an advertisement to the user for the supermarket when the encounter processing platform 103 suggests an encounter for the bar in question. Because the probability is high, or at a particular threshold value, a notification may be sent to an advertiser that the likelihood of attendance is high (step 313). Based on this notification, the advertiser would have the option of sending an advertisement, or allowing an advertisement to be sent, to the user and/or the one or more other users. Next, the process optionally continues to step 315 in which the encounter processing platform 103 generates a pricing schedule for the cost of the advertisement. For example, the cost of the advertisement may be based on a set scale that is dependent on the probability that the user will attend the proposed social encounter. For instance, if the probability is over 50%, then the advertiser would pay more such an advertisement than a proposed encounter where the probability of attendance is below 40%. The encounter processing platform 103 may also entertain bids from advertisers to win advertising opportunities based on the particular probability thresholds that are reached. The encounter processing platform 103 may take all of this information into consideration when generating a proposed social encounter for the user.

The process optionally continues to step 317 in which the encounter processing platform 103 may generate at least one invitation that may be sent to the user and/or the one or more other users to attend a proposed social encounter. For example, the invitation may have information directing any recipient of the invitation to go to a particular place at a particular time and meet up with a list of particular people that may or may not have been recipients themselves of the invitation. The process optionally continues to step 319 in which the encounter processing platform 103 may send the at least one generated advertisement to the user and/or the one or more other users along with the invitation. The advertisement may be incorporated into the invitation, it may be listed in a list of things to do or options, or it may be sent as an attachment to an email or a separate email, text or picture message to the user and/or the one or more other users. The invitation may be received any number of ways, for example, via text message, video message, picture message, email, voice message or voicemail, instant message, etc.

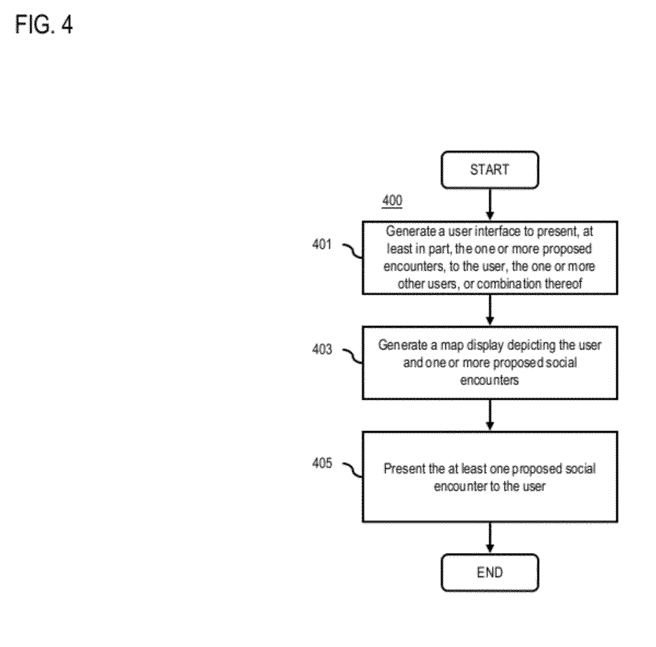

FIG. 4 is a flowchart of a process for generating a user interface for presenting one or more proposed social encounters according to one embodiment. In step 401 the encounter processing platform 103 generates a user interface display that is to be displays on the UE 101 that presents the one or more proposed encounters. The presentation may be any formation that conveys information to a user. For example, the presentation may be in the form of a list of detailed options for proposed encounters that the user may attend. The user interface may also present information such as location, time, attendees, specials/advertisements, etc. Alternatively, or in addition to, the process may continue to step 403 in which a map display is generated that depicts the locations of proposed social encounters relative to a location of the user or an anchor location that may be set by the user such as an area of interest. The map user interface may also illustrate the number of attendees that may attend a proposed social encounter. The process continues to step 405 in which the at least one social encounter is presented to the user by way of the list user interface, map user interface, and/or invitation, as discussed above.

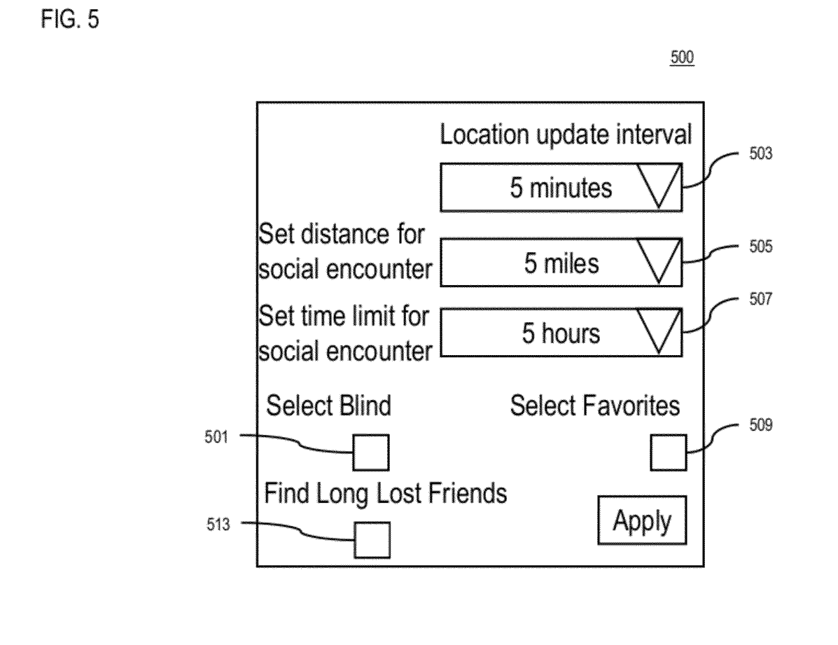

FIG. 5 is a diagram of a user interface 500 for setting a plurality of preferences for proposing at least one social encounter, according to one embodiment. The user interface 500 incorporates a number of selectable features to enhance a social encounter proposal. A check box 501 may enable a user to select a blind option so that he does not know who he is meeting at a proposed social encounter. The blind option could be a surprise friend that the user already knows through the social network 113 or a complete stranger that also uses the social network and is interested in meeting someone blindly at a location at a particular time. A drop-down box 503 provides an option to update the location information of the UE 101 at a particular time period. This allows for the user to always have up to date information available for the encounter processing platform so that various social encounters may be proposed. The continuous location updating at particular times also makes the user's location known for other UE's that may be running a social encounter proposal application. A drop-down box 505 provides an option to set a distance around a user's detected location within which the user wants to receive social encounter proposals. For example, if the user does not want to travel more than 5 miles to meet up with friends, the user may set the range to be 5 miles or less. Alternatively, the user may want to get away from his current location so the user may set the range to be great than a particular distance. Or, the user may optionally input a specific location that is not related to his present detected location around which the user may specify a range for a proposed social encounter. The user interface 500 may also have a drop down box 507 that provides for an option to set a particular time within which or a time at which a social encounter is desired. For example, if a user is at work, but wants to meet friends later in the evening, the user may set a time that occurs later that day. Or, the user could select a range of time. The encounter processing platform 103 could then use the time range to optimize the user and the one or more other users to best match up probable times of availability. The encounter processing platform 103 may also access the user's and other user's social calendars to determine when a user and his friends may be available to meet, or to weed out people that are simple busy at any requested time. The user interface 500 may also have a check box 509 that is used to identify favorite friends to limit the scope of available encounter candidate, or to specifically remove individuals from being suggested. For example, if a user has 500 friends according to his social networking profile 115a, but really only wants to hang out with 10 of those friends, those friends could be favorited and used in the search process. Or, if there is a particular person that the user is connected to on the social network 113, but has no desire to see, that person may be removed from the query so that any annoyance or inconvenience may be avoided. The user may use the favorites option to specifically select recipients of the invitation from a list of known users such as from a list in his contacts that are resident on the UE 101 or from a list of contacts that are stored as part of his social networking profile 115a.

The user interface 500 may also have a check box 511 for searching for long lost friends. If a user's communication records identify members of the social networking service 113 with whom the user has not had contact in a while, and this option is selected, encounter processing platform 103 may recommend people with whom the user should arrange some face to face activities so that the user does not lose contact with these other users.

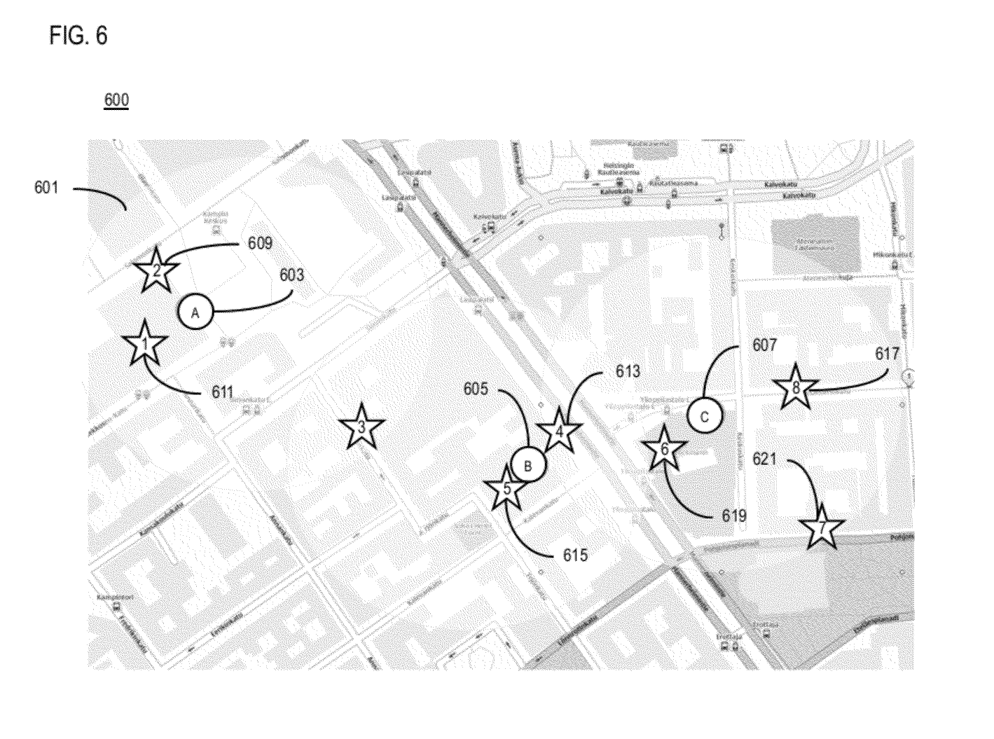

FIG. 6 is a diagram of a user interface 600, according to one embodiment, that illustrates a map 601 having a plurality of proposed social encounter anchor locations 603, 605, and 607 around which a number of proposed social encounters are proposed (encounters 609-619). Each of the encounters 609-619 may illustrate various alternatives that the user may attend and be based on preferences set by the user, his current location, a location of interest, social interest information, and any other information about one or more other users that may be received by the encounter processing platform 103. A user may select any of the proposed encounters 609-619 to get more information about the encounter such as who may attend, should an invitation be sent, what is the proposed encounter, how much might it cost, what time is the proposed encounter, whether the user is going to attend the proposed encounter so that the system 100 may relay that information to the one or more other users that an rsvp has been made, etc.

In other words, the user can request a recommendation as to what to do in a certain target time slot, e.g., 5 hours from the present moment. An output of the recommendation process is a set of geo-social-commercial recommendations, each of which represent a realistic geo-social context, from the point of view of the person's geographic and social routines. As only one of the recommendations can actualize, in respect to one another, the recommendations can be seen as “parallel universes”, or alternative future states of the user. For example, consider the following propositions: At 8 PM tonight, the system 100 tells a user that he could be having coffee with Julia and Rob, or the user could be throwing darts in a bar with his friends Ollie and Jack.

The outcome of the proposal process for a social encounter may be affected by the following aspects:

1. Possible locations of the person himself at the target time slot, based on historical present-moment-to-target-slot location sequences pertaining to that individual, as recorded at the backend of the service,

2. Commercial content available from third parties (e.g. free coffee at all Starbucks, reduced beer in Duff's bar, discounted bowling at Joe's bowling place, etc.), in the proximity of the above locations, and

3. People who are predicted to be nearby the locations identified in the above steps.

Each of the recommended future states is associated with a location (often commercial), a list of people who could join the user in the given location (based on the present and anticipated future locations of members of the user's social network 113 as well as availability of these individuals at the target time slot) and location based commercial content available in the given location.

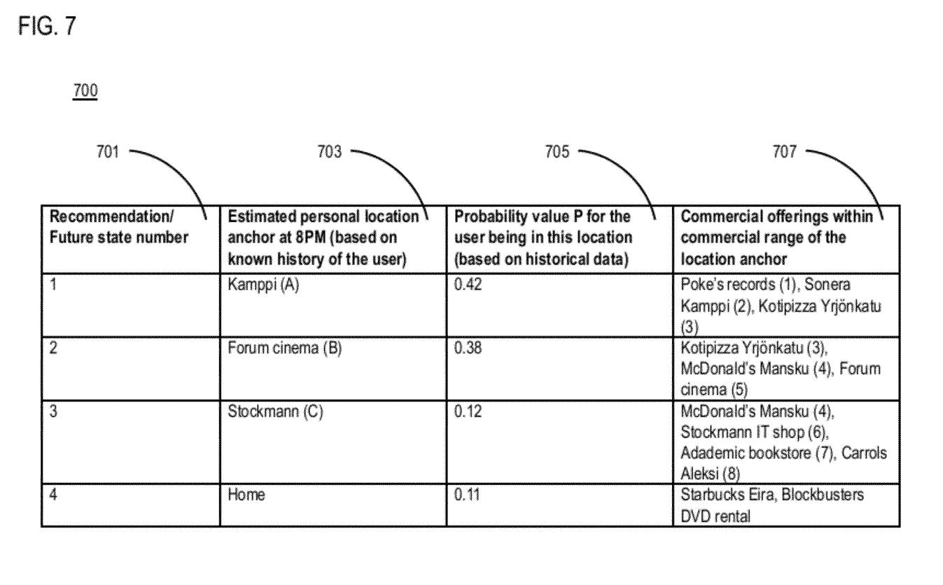

FIG. 7 is an illustration of a user interface 700, according to one embodiment, that provides a list 703 of anchor locations around which the proposed social encounters may be based. The anchor locations are based on locations of interest that may be set by the user, generated based on a user's historical movement, or the user's current location. The user interface 700 also provides a listing of probabilities that the user it likely to be in the vicinity of the generated anchor location 703, and a list of commercial availability information 707. The commercial availability information 707 may be information about any commercial establishment that that is within a proximity of the anchor locations, or may be the anchor location itself. The commercial availability information may be based on actual availability such as available tables, sold out shows or events, etc.

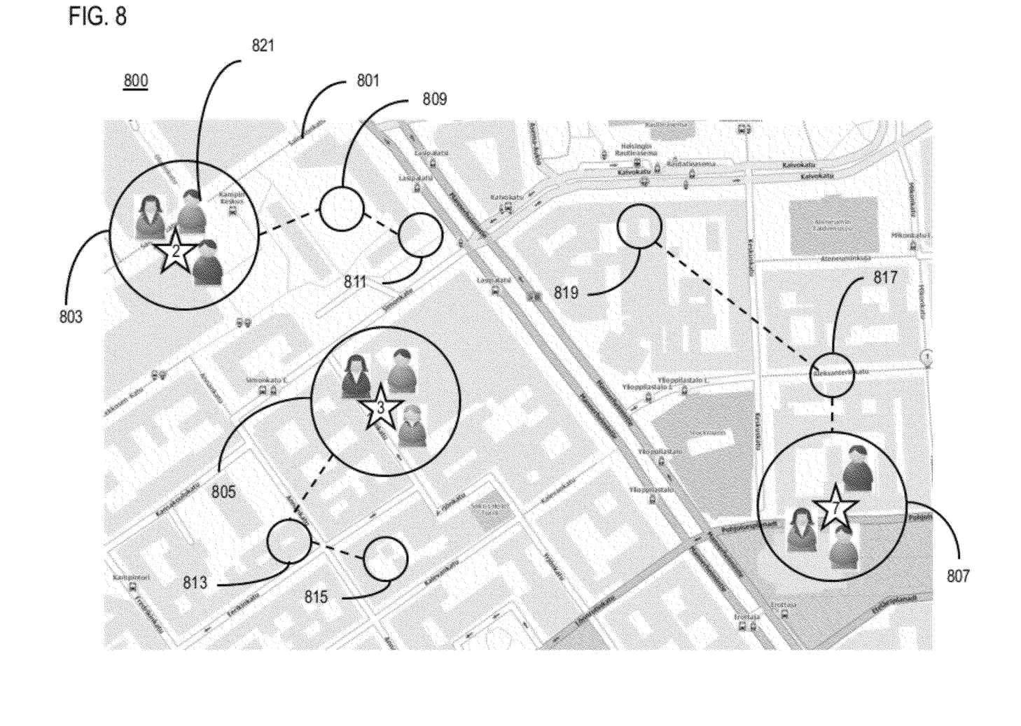

FIG. 8 is a diagram of a user interface 800, according to one embodiment, that illustrates a number of users and proposed social encounters 803-807 and their locations on a map 801. The social encounters 803-807 may act as anchor locations themselves for other future proposed encounters that may transpire as a result of attending any of the proposed social encounters. For example, if a user attends a proposed social encounter at 803, as a result, he may be offered other encounters at 809 and 811. In this example, imagine that encounter 803 is a first bar, but because the user is in that particular area of town, the encounter processing platform 103 may suggest other social encounters in the area, i.e. encounters 809 and 811, that may occur at later times and illustrate a path of travel between each of the proposed social encounters. Similarly, paths may be mapped from anchor social encounters 805 and 807 to additional proposed encounters 813-819 so that the user can visualize how his future may go in alternative universes. Several commercial offerings can be included in one specific proposed social encounter. In other words, a user and other users, for instance, may wish to go to a mall, but because they are going to the mall, the group might be interested in doing several things, such as going to cinema, having dinner afterwards, and then going to the amusement park located in the mall, or to a bar or a party registered with the social networking service 113. The map 800, therefore illustrates this potential progression of events, and illustrates them parallel with alternative paths.

Using the map 800 type interface, the proposed social encounters can each be selected further scrutiny, for example, by double clicking on a recommended object 803-819. When selecting/highlighting any given future location from the map, a new view may be brought to the foreground of the application, representing a “future peak” to the given context. This view can entail a virtual environment of an area around the selected location that has been tailored according to the characteristics of the actual location that is recommended to the user (such graphical environments can be tailored by the third parties and stored on a server, for example).

Additionally, users may select an avatar 821 to represent them in interactions taking place through the encounter proposal process. The avatars 821 of the persons who could find themselves in that geo-social context or location are also displayed in the map 800. The commercial offering or advertisement discussed above associated with that particular location may be conveyed to the user through e.g. text or animated actions of characters associated with that location (e.g. a bartender or a salesman at coffee shop tells the user that there is free coffee available).

The user can opt for any given proposed social encounter and “make it happen”. In such a case, a message is sent to the other users who have been identified for that particular proposed social encounter. The message could replay the same visual scene as was originally seen by the user having chosen to attend that proposed social encounter. Additionally, the message could contain some personalized text from the user: e.g., “John and Mary, how about some beer tonight? The first drink is on me”. The recipients of the invite can accept or reject the invite and the status of the invite can be tracked by attendees of this future event using the social networking service 113, or another application that is run by the encounter processing platform 103.

Once in the location, upon accepting the invitation, or with the notification, the encounter processing platform 103 could provide the “attendees” with electronic coupons to actualize the offer that was provided to them through the service. The coupons could allow them to get price reductions on products or services that were included in the offer/ad.

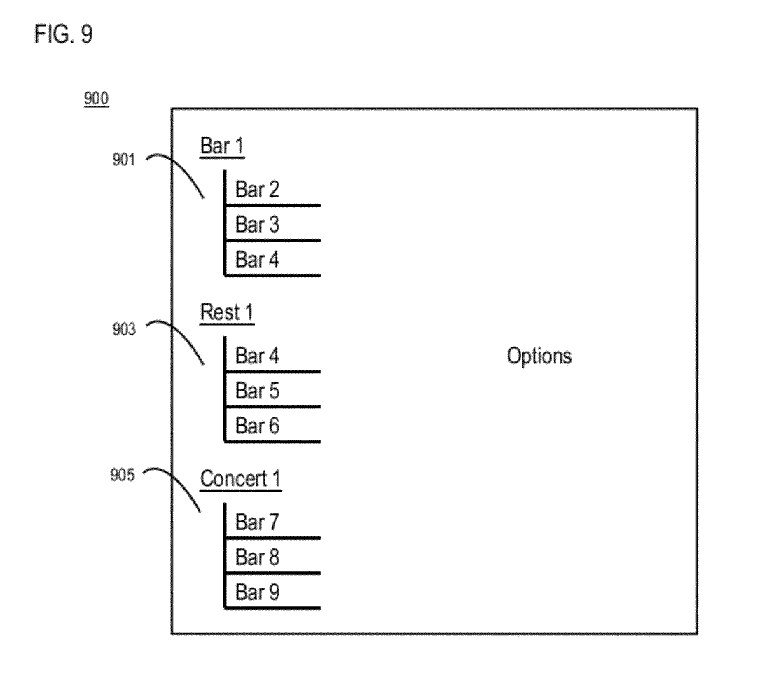

FIG. 9 is a diagram of a user interface 900, according to one embodiment, that illustrates a hierarchical list of proposed social encounters 901-905 and any later events that could transpire as a result of attending any of the proposed social encounters 901-905. The user may have the ability to select any of the encounters 901-905 to delve deeper into the details about the proposed social encounter or any of the sub encounters to determine if the user wants to attend the proposed social encounters and indicate his intentions to do so by alerting the other users that are proposed as attendees.

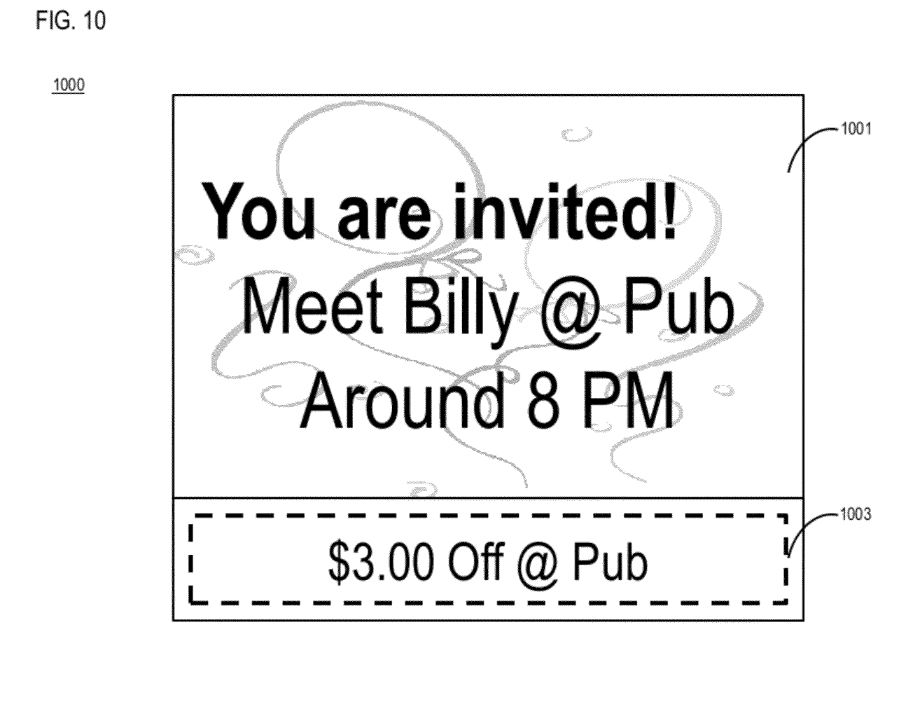

FIG. 10 is a diagram of an example invitation 1000 that may be sent to the user and/or one or more of the other users, according to one embodiment. The invitation has at least two primary sections, a details section 1001 and a commercial section 1003. The details section 1001 describes the who, what, when, why and where of a proposed social encounter. The commercial section 1003 may provide at least one advertisement that relates to the proposed social encounter. The commercial section 1003 may be fixed, or it may be a refreshing banner that may provide a plurality of advertisements, or changing information, for example. Each of the details section 1001 and the commercial section 1003 may be a live link that may be selectable to switch to another web page, for example, to get more details about the event such as directions, or more information about the establishment or location.

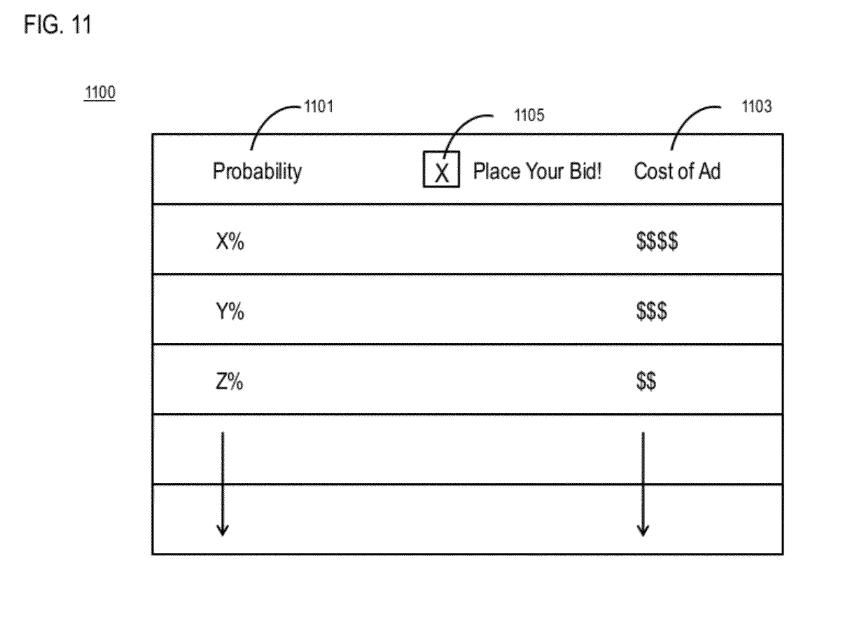

FIG. 11 is an example user interface having a list 1100, according to one embodiment, that may be used to set probability threshold values 1101 and their corresponding costs for placing an advertisement 1103. The list 1100 may be a means for notifying potential advertisers of what the current pricing schedule is for placing an ad, but it may also provide an indication that an auction may be available to receive prime placement. For example, if a commercial establishment wants to ensure that their advertisement is sent to the user for a proposed social encounter that has a high probability of occurring, or an anchor location that has a high probability of occurring, then a decision maker for the commercial establishment may optionally bid to spend more money than other commercial establishments, for example at a value higher than an agreed upon baseline cost of placing the ad for a particular probability, to ensure that their ad is sent to the user. The bid may be placed by selecting a bid option 1105, for example.

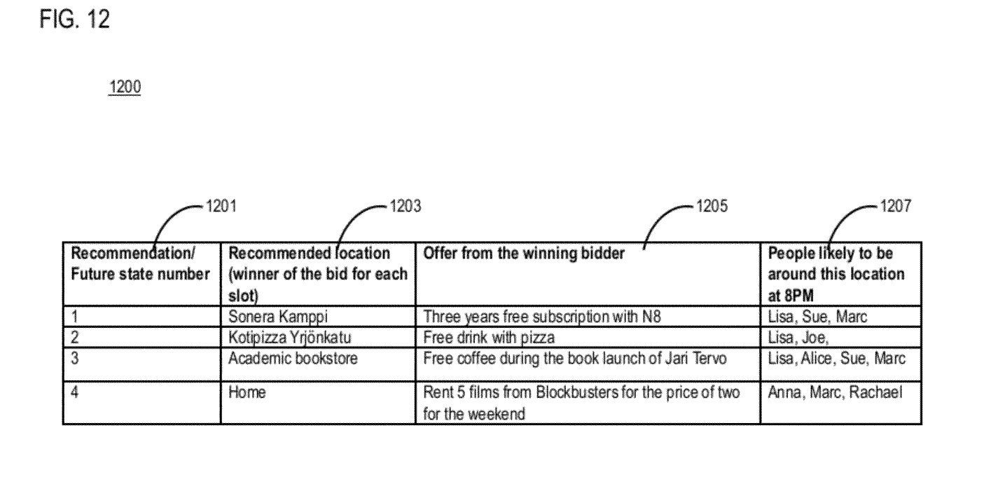

FIG. 12 is an example user interface having a list 1200, according to one embodiment, that may be used to provide a clear representation of proposed encounter 1201, a proposed location for the proposed encounter 1203, a commercial offer from a winning bidder 1205, and the people that are likely to be at the proposed encounter and/or within the vicinity of a particular location of interest, for example, 1207. The list 1200 provides a listing of the winning bidders 1203 that ensured that their advertisement is sent to the user and/or the other users for respective proposed encounter scenarios 1201. The list also provides specific details about what the advertisement or discount offer is from the winning bidder at 1205. The list 1200 also indicates what users are likely, based on their behavioral patterns, interests, invites, RSVP's to other events, are likely to attend a proposed encounter, or be in the vicinity of the proposed encounter. For example, Lisa, Alice, Sue and Marc are likely to be near the “Academic Bookstore” at a time of day, so these users may be notified by the encounter processing platform 103 that they should all get together at the bookstore at 8 pm, for example. To entice these users to attend the proposed event, they may view a list interface such as the one illustrated in FIG. 12 and see the plurality of options for social encounters 1201, the proposed locations 1203 proposed attendees 1207 and the commercial offers 1205. This presentation, as discussed above, may also be by way of a map display, or a map display that may be selectable to yield such a list display, by invitation, or any other means for communicating information such as a text message, email message, voice message, etc.

The processes described herein for proposing a social encounter may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

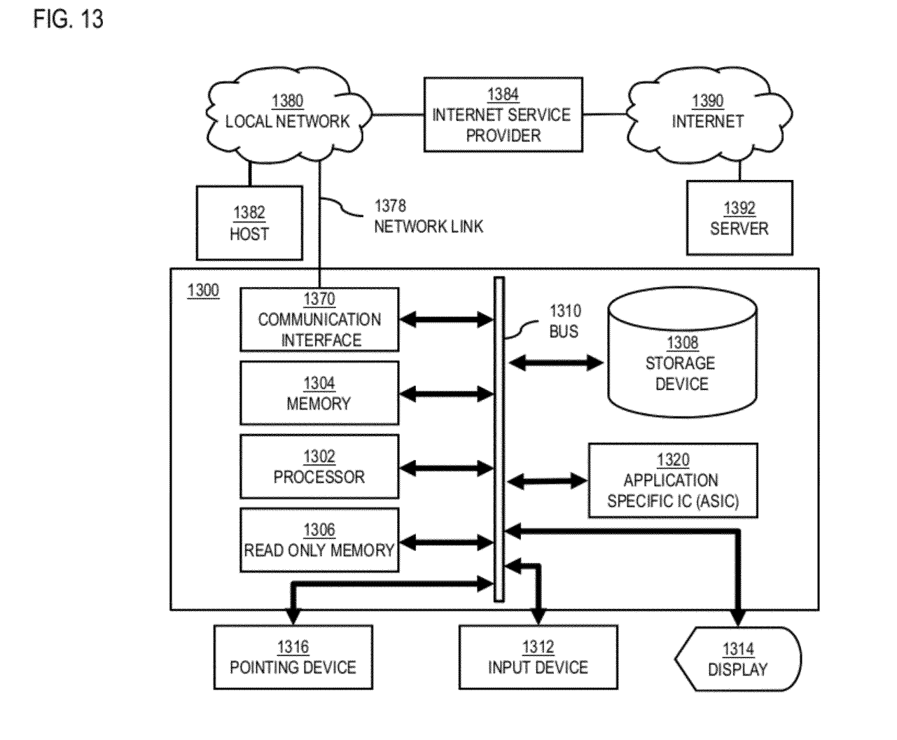

FIG. 13 illustrates a computer system 1300 upon which an embodiment of the invention may be implemented. Although computer system 1300 is depicted with respect to a particular device or equipment, it is contemplated that other devices or equipment (e.g., network elements, servers, etc.) within FIG. 13 can deploy the illustrated hardware and components of system 1300. Computer system 1300 is programmed (e.g., via computer program code or instructions) to propose a social encounter as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1300, or a portion thereof, constitutes a means for performing one or more steps of proposing a social encounter.

A bus 1310 includes one or more parallel conductors of information so that information is transferred quickly among devices coupled to the bus 1310. One or more processors 1302 for processing information are coupled with the bus 1310.

A processor (or multiple processors) 1302 performs a set of operations on information as specified by computer program code related to propose a social encounter. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1300 also includes a memory 1304 coupled to bus 1310. The memory 1304, such as a random access memory (RAM) or any other dynamic storage device, stores information including processor instructions for proposing a social encounter. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or any other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for proposing a social encounter, is provided to the bus 1310 for use by the processor from an external input device 1312, such as a keyboard containing alphanumeric keys operated by a human user, or a sensor. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT), a liquid crystal display (LCD), a light emitting diode (LED) display, an organic LED (OLED) display, a plasma screen, or a printer for presenting text or images, and a pointing device 1316, such as a mouse, a trackball, cursor direction keys, or a motion sensor, for controlling a position of a small cursor image presented on the display 1314 and issuing commands associated with graphical elements presented on the display 1314. In some embodiments, for example, in embodiments in which the computer system 1300 performs all functions automatically without human input, one or more of external input device 1312, display device 1314 and pointing device 1316 is omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of ASICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 105 for proposing a social encounter to the UE 101.

The term “computer-readable medium” as used herein refers to any medium that participates in providing information to processor 1302, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1308. Volatile media include, for example, dynamic memory 1304. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1320.

Network link 1378 typically provides information communication using transmission media through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390.

A computer called a server host 1392 connected to the Internet hosts a process that provides a service in response to information received over the Internet. For example, server host 1392 hosts a process that provides information representing video data for presentation at display 1314. It is contemplated that the components of system 1300 can be deployed in various configurations within other computer systems, e.g., host 1382 and server 1392.

At least some embodiments of the invention are related to the use of computer system 1300 for implementing some or all of the techniques described herein. According to one embodiment of the invention, those techniques are performed by computer system 1300 in response to processor 1302 executing one or more sequences of one or more processor instructions contained in memory 1304. Such instructions, also called computer instructions, software and program code, may be read into memory 1304 from another computer-readable medium such as storage device 1308 or network link 1378. Execution of the sequences of instructions contained in memory 1304 causes processor 1302 to perform one or more of the method steps described herein. In alternative embodiments, hardware, such as ASIC 1320, may be used in place of or in combination with software to implement the invention. Thus, embodiments of the invention are not limited to any specific combination of hardware and software, unless otherwise explicitly stated herein.

The signals transmitted over network link 1378 and other networks through communications interface 1370, carry information to and from computer system 1300. Computer system 1300 can send and receive information, including program code, through the networks 1380, 1390 among others, through network link 1378 and communications interface 1370. In an example using the Internet 1390, a server host 1392 transmits program code for a particular application, requested by a message sent from computer 1300, through Internet 1390, ISP equipment 1384, local network 1380 and communications interface 1370. The received code may be executed by processor 1302 as it is received, or may be stored in memory 1304 or in storage device 1308 or any other non-volatile storage for later execution, or both. In this manner, computer system 1300 may obtain application program code in the form of signals on a carrier wave.

Various forms of computer readable media may be involved in carrying one or more sequence of instructions or data or both to processor 1302 for execution. For example, instructions and data may initially be carried on a magnetic disk of a remote computer such as host 1382. The remote computer loads the instructions and data into its dynamic memory and sends the instructions and data over a telephone line using a modem. A modem local to the computer system 1300 receives the instructions and data on a telephone line and uses an infra-red transmitter to convert the instructions and data to a signal on an infra-red carrier wave serving as the network link 1378. An infrared detector serving as communications interface 1370 receives the instructions and data carried in the infrared signal and places information representing the instructions and data onto bus 1310. Bus 1310 carries the information to memory 1304 from which processor 1302 retrieves and executes the instructions using some of the data sent with the instructions. The instructions and data received in memory 1304 may optionally be stored on storage device 1308, either before or after execution by the processor 1302.

FIG. 14 illustrates a chip set or chip 1400 upon which an embodiment of the invention may be implemented. Chip set 1400 is programmed to propose a social encounter as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1400 can be implemented in a single chip. It is further contemplated that in certain embodiments the chip set or chip 1400 can be implemented as a single “system on a chip.” It is further contemplated that in certain embodiments a separate ASIC would not be used, for example, and that all relevant functions as disclosed herein would be performed by a processor or processors. Chip set or chip 1400, or a portion thereof, constitutes a means for performing one or more steps of providing user interface navigation information associated with the availability of functions. Chip set or chip 1400, or a portion thereof, constitutes a means for performing one or more steps of proposing a social encounter.

In one embodiment, the chip set or chip 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1400 includes merely one or more processors and some software and/or firmware supporting and/or relating to and/or for the one or more processors.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to propose a social encounter. The memory 1405 also stores the data associated with or generated by the execution of the inventive steps.

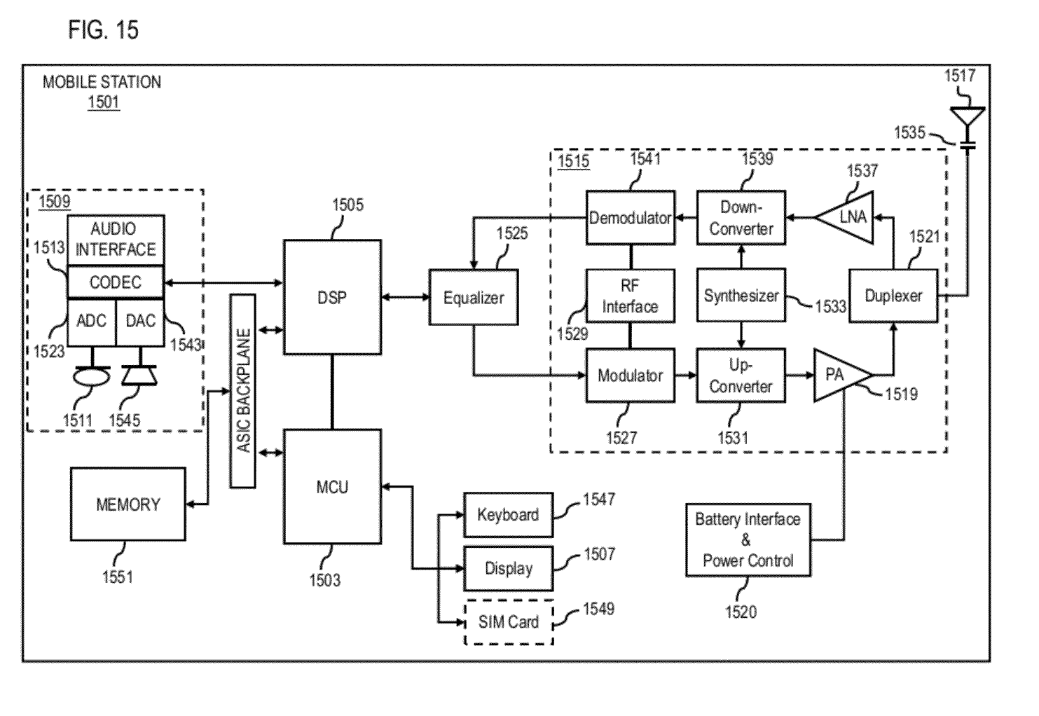

FIG. 15 is a diagram of exemplary components of a mobile terminal (e.g., handset) for communications, which is capable of operating in the system of FIG. 1, according to one embodiment. In some embodiments, mobile terminal 1501, or a portion thereof, constitutes a means for performing one or more steps of proposing a social encounter. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile terminal functions that perform or support the steps of proposing a social encounter. The display 1507 includes display circuitry configured to display at least a portion of a user interface of the mobile terminal (e.g., mobile telephone). Additionally, the display 1507 and display circuitry are configured to facilitate user control of at least some functions of the mobile terminal. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile terminal 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503 which can be implemented as a Central Processing Unit (CPU) (not shown).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile terminal 1501 to propose a social encounter. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the terminal. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile terminal 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable storage medium known in the art. The memory device 1551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1549 carries, for instance, important information, such as the cellular phone number, the carrier supplying service, subscription details, and security information. The SIM card 1549 serves primarily to identify the mobile terminal 1501 on a radio network. The card 1549 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
location information associated with a user and other location information associated with one or more other users;
social interest information associated with the user and other social interest information associated with the one or more other users;
a processing of the location information, the other location information, the social interest information, the other social interest information or combination thereof to cause, at least in part, identification of one or more proposed encounters with respect to the user and the one or more other users; and
at least one determination to generate a presentation of the one or more proposed encounters to the user.

2. A method of claim 1, wherein the (1) data and/or (2) information and/or (3) at least one signal are further based, at least in part, on the following:
a processing of the one or more proposed encounters to generate at least one invitation to attend at least one of the one or more encounters.

3. A method of claim 2, wherein the (1) data and/or (2) information and/or (3) at least one signal are further based, at least in part, on the following:
commercial availability information associated with the location information, the other location information, the social interest information, the other social interest information, a location of the proposed one or more encounters, or a combination thereof; and
a processing of the commercial availability information to cause, at least in part, an optimization of the one or more proposed encounters.

4. A method of claim 3, wherein the (1) data and/or (2) information and/or (3) at least one signal are further based, at least in part, on the following:
a processing of the commercial availability information to cause, at least in part, generation of at least one advertisement corresponding to the commercial availability information, wherein the at least one advertisement is distributed to the user, the one or more other users, or a combination thereof.

5. A method of claim 4, wherein the at least one advertisement is distributed along with the invitation to the one or more proposed encounters.

6. A method of claim 4, wherein the (1) data and/or (2) information and/or (3) at least one signal are further based, at least in part, on the following:
a determination of a probability that the user will attend the one or more proposed encounters;
a processing of the probability to cause, at least in part, a transmission of a notification to one or more advertisers that the probability is above a threshold value; and
a generation of a cost of the at least one advertisement based on the probability.

7. A method of claim 1, wherein the (1) data and/or (2) information and/or (3) at least one signal are further based, at least in part, on the following:
a range within which the one or more proposed encounters is deemed valid.

8. A method of claim 1, wherein the (1) data and/or (2) information and/or (3) at least one signal are further based, at least in part, on the following:
a processing of additional location information to cause, at least in part, identification of additional one or more proposed encounters with respect to the user and the one or more other users.

9. A method of claim 1, wherein the (1) data and/or (2) information and/or (3) at least one signal are further based, at least in part, on the following:
a user interface to present, at least in part, the one or more proposed encounters, to the user, the one or more other users, or combination thereof.

10. A method of claim 9, wherein the user interface includes, at least in part, a map display depicting the user, the one or more other users, the one or more proposed encounters, or combination thereof.

11. An apparatus comprising:
at least one processor; and
at least one memory including computer program code for one or more programs,
the at least one memory and the computer program code configured to, with the at least one processor, cause the apparatus to perform at least the following,
determine location information associated with a user and other location information associated with one or more other users;
determine social interest information associated with the user and other social interest information associated with the one or more other users;
process and/or facilitate a processing of the location information, the other location information, the social interest information, the other social interest information or combination thereof to cause, at least in part, identification of one or more proposed encounters with respect to the user and the one or more other users; and
cause, at least in part, a generation of a presentation of the one or more proposed encounters to the user.

12. An apparatus of claim 11, wherein the apparatus is further caused to:
process and/or facilitate a processing of the one or more proposed encounters to generate at least one invitation to attend at least one of the one or more encounters.

13. An apparatus of claim 12, wherein the apparatus is further caused to:
determine commercial availability information associated with the location information, the other location information, the social interest information, the other social interest information, a location of the proposed one or more encounters, or a combination thereof; and
process and/or facilitate a processing of the commercial availability information to cause, at least in part, an optimization of the one or more proposed encounters.

14. An apparatus of claim 13, wherein the apparatus is further caused to:
process and/or facilitate a processing of the commercial availability information to cause, at least in part, generation of at least one advertisement corresponding to the commercial availability information, wherein the at least one advertisement is distributed to the user, the one or more other users, or a combination thereof.

15. An apparatus of claim 14, wherein the at least one advertisement is distributed along with the invitation to the one or more proposed encounters.

16. An apparatus of claim 14, wherein the apparatus is further caused to:
determine a probability that the user will attend the one or more proposed encounters;
process and/or facilitate a processing of the probability to cause, at least in part, a transmission of a notification to one or more advertisers that the probability is above a threshold value; and
cause, at least in part, a generation of a cost of the at least one advertisement based on the probability.

17. An apparatus of claim 11, wherein the apparatus is further caused to:
determine a range within which the one or more proposed encounters is deemed valid.

18. An apparatus of claim 11, wherein the apparatus is further caused to:
process and/or facilitate a processing of additional location information to cause, at least in part, identification of additional one or more proposed encounters with respect to the user and the one or more other users.

19. An apparatus of claim 11, wherein the apparatus is further caused to:
cause, at least in part, generation of a user interface to present, at least in part, the one or more proposed encounters, to the user, the one or more other users, or combination thereof.

20. An apparatus of claim 19, wherein the user interface includes, at least in part, a map display depicting the user, the one or more other users, the one or more proposed encounters, or combination thereof.
